(19) United States
(12) Patent Application Publication
(10) Pub. No.: US 2010/0026269 A1
(43) Pub. Date: Feb. 4, 2010

(54) Output voltage compensation device

(76) Inventor: Jack Zhiang, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,868

(22) Filed: Jul. 30, 2008

(51) Int. Cl. G05F 1/10

(52) U.S. Cl. 323/298

(57) ABSTRACT

An output voltage compensation device has a Bark converter, a current detection resistance, a sense resistance, a voltage feedback circuit and a Pulse Width Modulation (PWM) controller. The current detection resistance is series connected with an output end of the Bark converter. Voltage at a front end of the current detection resistance is detected by the sense resistance, and compares with actual output voltage. Based on the compared result, the PWM controller adjusts work cycle of the Bark converter for voltage compensation.

### BACKGROUND OF THE INVENTION

1. Field of the Invention

The present invention relates to an output voltage compensation device, and particularly relates to an output voltage compensation device which compensates voltage consumed by wire resistance and connector resistance so that output voltage adjustment ratio coincides with practical design.

2. Related Art

Recently portable electronic products are booming. Correspondingly, vehicle charge products have tendency of raising output current specification to be adapted for the electronic products. Circuit voltage relatively rises, making voltage adjustment ratio be apt to exceed acceptable scopes of the electronic products. A conventional solution is to provide a V sense wire on output wire for detecting actual output voltage of the end of output wire and compensating output voltage. This solution, however, can not compensate output voltage effectively.

### SUMMARY OF THE INVENTION

Accordingly, an object of the present invention is to provide an output voltage compensation device which effectively compensates voltage and stably outputs voltage and which simplifies manufacture process and costs down.

The output voltage compensation device comprises a Buck converter, a current detect, a voltage feed back circuit and a PWM controller. The current detect resistance is series connected with an output end of the Buck converter. A sense resistance is series connected with a front end of the current detection resistance for detecting voltage signals. Voltage at a voltage setting point of the PWM controller is promoted according to the detected voltage signals, thereby adjusting work cycle of the Bark converter for voltage compensation.

### BRIEF DESCRIPTION OF THE DRAWINGS

FIG. 1 is a circuit diagram of an output voltage compensation device according to a first embodiment of the present invention.

FIG. 2 is a circuit diagram of an output voltage compensation device according to a second embodiment of the present invention.

FIG. 3 is a block graph of a PWM controller 3′ of FIG. 2.

### DESCRIPTION OF THE PREFERRED EMBODIMENTS

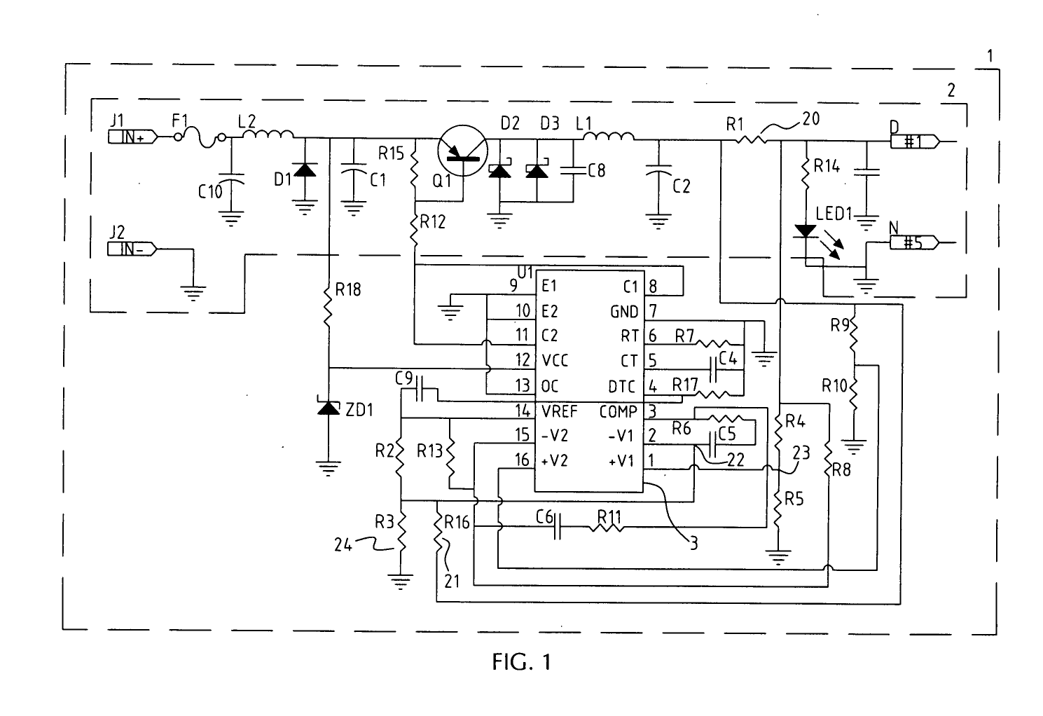

FIG. 1 shows an output voltage compensation device according to a first embodiment of the present invention. With reference to FIG. 1, the output voltage compensation device comprises a Buck converter 2, a current detection resistance 20, a sense resistance 21, a voltage-divide resistance 24, a voltage setting point 22, a voltage feedback point 23 and a Pulse Width Modulation (PWM) controller 3. The PWM controller 3 may be similar products available on market. The current detection resistance 20 is connected with an output end of the Buck converter 2. A front end of the current detection resistance 20 is connected by wire with the sense resistance 21. The sense resistance 21 detects variation of voltage rise between two ends of the sense resistance 21 due to rise of output current. The voltage rise passes the sense resistance 21 and is voltage divided by the voltage-divide voltage 24, and finally raises the set voltage at the voltage setting point 22 of the PWM controller 3. Meanwhile voltage at the voltage feedback point 23 is lower than voltage at the voltage setting point 22. An OP AMP of the PWM controller 3 compares voltage at the voltage feedback point 23 and voltage at the voltage setting point 22, and passes the compared result to the PWM controller 3 to adjust work cycle of the Buck converter 2 for the purpose of compensating voltage. Notably, size of the sense resistance 21 is adjustable according to the detected voltage signals, thereby meeting output current of different product specifications and effectively compensating voltage.

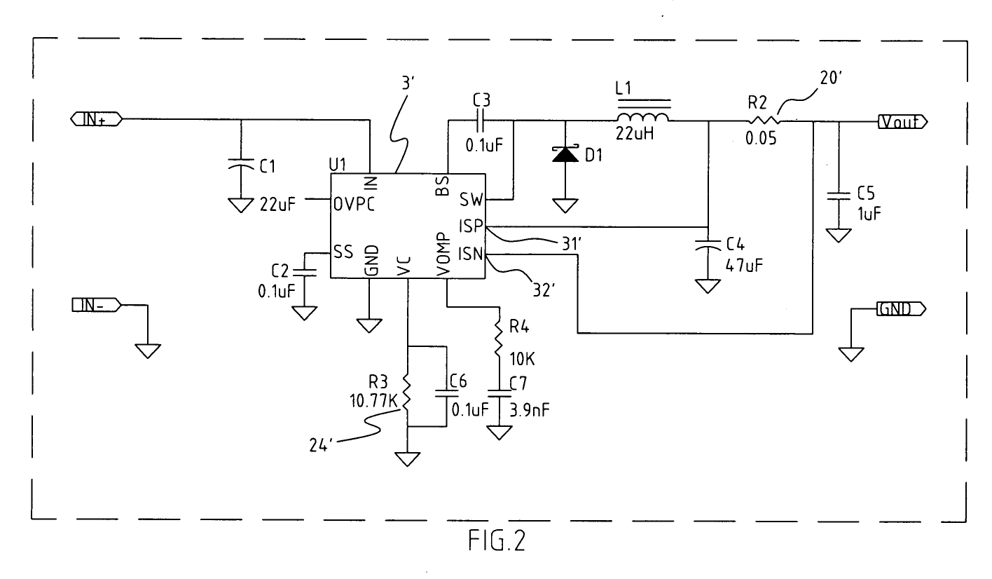

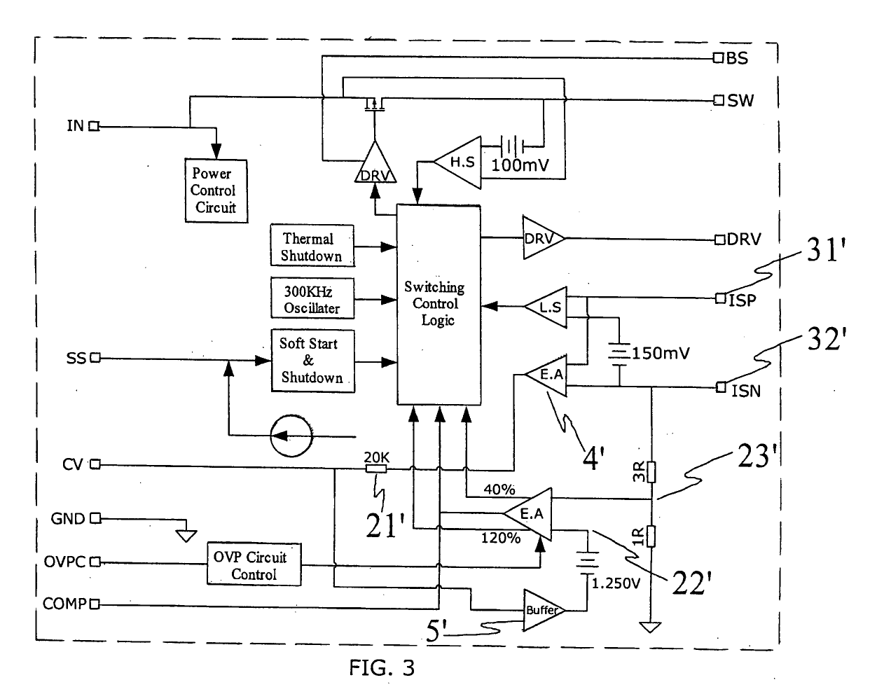

FIG. 2 shows an output voltage compensation device according to a second embodiment of the present invention. FIG. 3 is a block graph of a PWM controller 3′ in FIG. 2. Referring to FIG. 2, the output voltage compensation device of the second embodiment is similar to the first embodiment, and comprises a Buck converter (not labeled), a current detection resistance 20′, a sense resistance 21′, a voltage-divide resistance 24′, a voltage setting point 22′, a voltage feedback point 23′ and a Pulse Width Modulation (PWM) controller 3′. Referring to FIG. 3, the second embodiment is different from the first embodiment mainly because the PWM controller 3′ further includes an operational amplifier 4′ and a buffer amplifier 5′. The operational amplifier 4′ is series connected with a front end of the current detection resistance 20′ at the output end of the Buck converter. That is, two input end of the operational amplifier 4′ are parallel connected with the current detection resistance 20′ at the output end of the Buck converter. An output end of the operational amplifier 4′ is connected with the sense resistance 21′, and then is output from the PWM controller 3′ to be voltage divided by the voltage-divide resistance 24′, is finally connected to an input end of the buffer amplifier 5′. In this embodiment, a reference voltage at an output end of the buffer amplifier 5′ serves as output voltage setting of the Bark converter.

When output current rises, voltage at two ends of the current detection resistance 20′ rises, correspondingly. The increased voltage signal passes through an ISP pin 31′ and an ISN pin 32′ of the PWM controller 3′, and promotes output voltage of the operational amplifier 4′. The promoted output voltage passes the sense resistance 21′, and is then voltage divided by the voltage-divide resistance 24′. The voltage-divided signal promotes the voltage setting point 22′ of the operational amplifier 4′ by the buffer amplifier 5′ for adjusting work cycle of the PWM controller 3′. The PWM controller 3′ promotes voltage of the voltage feedback point 23′, stabilizing output voltage thereby compensating voltage. The size of the voltage-divide resistance 24′ is adjustable according to the detected voltage signal for meeting output current of different product specification, thereby effectively making voltage compensation.

The present examples and embodiments are to be considered in all respects as illustrative and not restrictive, and the invention is not to be limited to the details given herein. Numerous modifications, changes, variations, substitutions and equivalents will occur to those skilled in the art without departing from the spirit and scope of the present invention as defined by the appended claims.

1. An output voltage compensation device being adapted to make effective output voltage compensation and provide stable output voltage, and comprising a Bark converter, a current detection resistance connected with an output end of the Bark converter, and a Pulse Width Modulation (PWM) controller, a sense resistance being series connected to a front end of the current detection resistance at an output end of the Bark converter for detecting voltage signals, voltage at a voltage setting point of the PWM controller being promoted according to the detected voltage signals, thereby adjusting work cycle of the Bark converter for the purpose of voltage compensation.

2. The output voltage compensation device as claimed in claim 1, wherein size of the sense resistance is adjustable according to the detected voltage signals for meeting output current of different product specifications.

3. The output voltage compensation device as claimed in claim 2, wherein the PWM controller further includes an operational amplifier and a buffer amplifier, the operational amplifier being series connected with a front end of the current detection resistance at the output end of the Buck converter, an output end of the operational amplifier being connected with the sense resistance and then being voltage divided by the voltage-divide resistance, and finally being connected to an input end of the buffer amplifier.

4. The output voltage compensation device as claimed in claim 3, wherein a reference voltage at an output end of the buffer amplifier serves as output voltage setting of the Bark converter.

5. The output voltage compensation device as claimed in claim 3, wherein size of the voltage-divide resistance is adjustable according to the detected voltage signal for meeting output current of different product specification.
